(19) United States
(12) Patent Application Publication
(10) Pub. No.: US 2009/0212137 A1
(43) Pub. Date: Aug. 27, 2009

(54) High Pressure Seal Construction, Method For Machining High Pressure Contact Surface and Fuel Injector

(76) Inventors: Osamu Kubota, Saitama (JP); Takayuki Yui, Saitama (JP); Hideo Furukawa, Saitama (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/917,291

(22) PCT Filed: Jun. 13, 2006
(86) PCT No.: PCT/JP2006/312210

§ 371 Date: May 1, 2009

(30) Foreign Application Priority Data
Jun. 15, 2005 (JP) 2005-174654

(51) Int. Cl. B05B 1/00; B23B 1/00

(52) U.S. Cl. 239/589; 82/1.11

(57) ABSTRACT

In a high pressure seal for a fuel injector formed by bringing a first contact surface of an injector housing to which a first fuel passage is made to open and a second contact surface of a nozzle body to which a second fuel passage is made to open into pressure contact with each other in a connecting portion of the first and second fuel passages, seal grooves of concentric circle form are applied to at least one of the contact surfaces by finish machining, thereby making it possible to suppress effectively the leakage of high-pressure fuel. The first contact surface and the second contact surface may be formed into concave shapes.

### TECHNICAL FIELD

The present invention relates to a high pressure seal construction that is used for a fuel injector which injects to supply fuel into a cylinder of an internal combustion engine, a method for machining a high pressure contact surface that is used in the high pressure seal construction, and a fuel injector.

### BACKGROUND ART

For example, in the case of a fuel injection system which employs a common rail, high-pressure fuel that is supplied from the common rail is configured to be delivered to fuel injectors that are fixed to cylinders of an internal combustion engine, so that the high-pressure fuel so delivered is then injected into the cylinders from the injectors. Incidentally, this type of fuel injector is made by attaching a nozzle body to a tip portion of an injector housing by means of a nozzle nut, and the high-pressure fuel from the common rail is configured to be delivered to a fuel gallery formed with a nozzle body through a fuel passage formed in such a manner as to straddle between the injector housing and the nozzle body.

In recent years, although the common rail pressure tends to be increased in order to reduce harmful substances in exhaust emissions, in the event that such high-pressurization is attempted, there is a possibility that a so-called micro-leakage occurs in which the high-pressure fuel within the fuel passage leaks from a high pressure contact surface formed between the injector housing and the nozzle body which constitutes a connection point with the fuel passage. Consequently, a high-performance high pressure seal construction has been longed for in which no such problem is caused even in the event that the high-pressurization of fuel that is supplied to the fuel injector is attempted.

Then, as is seen in JP-A-2003-139014 and JP-2003-139015, high pressure seal constructions have been proposed in which microscopic recessed portions are formed over a predetermined area on a contact surface and microscopic grooves are formed in such a manner as to be situated around a fuel passage. However, since the formation of microscopic recessed portions and microscopic grooves requires high accuracy in machining them, this causes other problems of increased labor hours in machining and increased production costs.

An object of the invention is to provide a high pressure seal construction for a fuel injector, a method for machining a high pressure contact surface and a fuel injector which can solve the aforesaid problems which are inherent in the related art.

Another object of the invention is to provide a high pressure seal construction for a fuel injector, a method for machining a high pressure contact surface and a fuel injector which can cope with the high-pressurization of fuel without making a major modification to a conventional product.

### DISCLOSURE OF THE INVENTION

With a view to solving the problems, a feature of the invention resides in a high pressure seal construction for a fuel injector that is made by bringing a housing end face of an injector housing to which a first fuel passage is made to open and a nozzle body end face of a nozzle body to which a second fuel passage is made to open into press contact with each other in a connecting portion of the first and second fuel passages, the high pressure seal construction being characterized in that, finish machining of concentric tool marks is applied to a high pressure contact surface of the high pressure seal construction.

Another feature of the invention resides in a method for finish machining a high pressure contact surface on an injector housing or a nozzle body of a fuel injector, characterized in that a finish machining tool is brought into press contact with the high pressure contact surface while rotating the injector housing or the nozzle body about an axis thereof as a rotating axis to thereby apply finish machining of concentric tool marks to the high pressure contact surface.

A further feature of the invention resides in a fuel injector which includes the aforesaid high pressure seal construction.

According to the invention, the problem of micro-leakage associated with the high-pressurization of fuel can be solved even on a conventional product without making a major modification thereto.

### BRIEF DESCRIPTION OF THE DRAWINGS

FIG. 1 is a sectional view of a main part which shows an embodiment of the invention.

FIG. 2 is an enlarged view of a bottom side of an injector housing in FIG. 1.

FIG. 3 is an enlarged view of a contact surface of a nozzle body in FIG. 1.

FIG. 4 is a drawing which shows another form of a contact surface.

FIG. 5 is a drawing which shows a further form of a contact surface.

FIG. 6 is a sectional view which shows an example of a nozzle body when the contact surface is made into a concave shape.

FIG. 7 is a sectional view of a high pressure seal portion when both contact surfaces are made into concave shapes.

FIG. 8A is a view as seen from the bottom side of the injector housing which explains an embodiment of a machining method according to the invention.

FIG. 8B is a view as seen from a side of the injector housing which explains the embodiment of the machining method according to the invention.

FIG. 9A is a view as seen from the bottom side of the injector housing which explains one other embodiment of a machining method according to the invention.

FIG. 9B is a view as seen from the side of the injector housing which explains the other embodiment of the machining method according to the invention.

### BEST MODE FOR CARRYING OUT THE INVENTION

The invention will be described according to the accompanying drawings for a detailed description thereof.

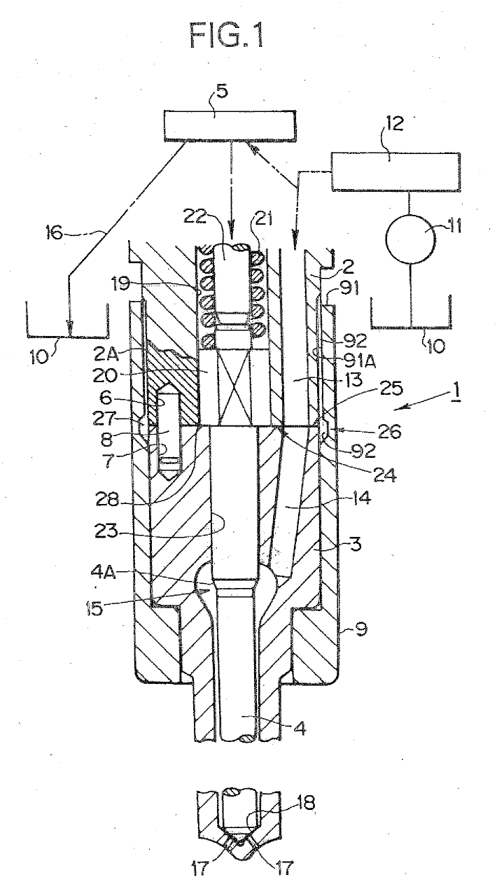

As is shown in FIG. 1, a fuel injector 1 according to the invention has an injector housing 2, a nozzle body 3, a nozzle needle 4 and a back pressure control unit 5. Two or more first positioning holes 6 (only one of the holes is seen in FIG. 1) and the same number of second positioning holes 7 (only one of the holes is seen in FIG. 1) are formed in the injector housing 2 and the nozzle body 3, respectively, so that the nozzle body 3 is mounted on a tip portion of the injector housing 2 by a nozzle nut 9 in a way which will be described later while being aligned with each other by positioning pins 8 which are inserted into the first positioning holes 6 and the second positioning holes 7, and the back pressure control unit 5 is provided in a position thereabove.

Fuel from a fuel tank 10 is pressurized by a fuel pump 11 and is stored in a common rail 12 as high-pressure fuel, and the high-pressure fuel is then supplied to the fuel injector 1. A first fuel passage 13 is formed in the injector housing 2, and a second fuel passage 14 is formed in the nozzle body 3, a fuel gallery 15 being formed in such a manner as to face a pressure-receiving portion 4A of the nozzle needle 4.

The high-pressure fuel from the common rail 12 can normally be supplied to the fuel gallery 15 through the first fuel passage 13 and the second fuel passage 14. Part of the first fuel passage 13 extends upwards as viewed in the figure so as to for a fuel return path 16 from the location of the back pressure control unit 5, so that the fuel is allowed to return to the fuel tank 10. The fuel return path 16 forms a leak passage of fuel together with a spring chamber 19, which will be described later.

An arbitrary number of fuel injection holes 17 are formed in a tip portion of the nozzle body 3. The injection holes 17 are made to be closed by a tip portion of the nozzle needle 4 being seated on a seat portion 18 which is formed in the vicinity of the injection holes 17, whereas the injection holes 17 are made to be opened by the tip of the nozzle needle 4 being lifted from the seal portion 18, so as to allow fuel to be injected therefrom.

A spring seat 20, a nozzle spring 21 adapted to bias the nozzle needle 4 in a direction in which the nozzle needle 4 is seated on the seal portion 18 and a valve piston 22 adapted to be brought into abutment with the spring seat 20 from above are provided in the spring chamber 19 which is formed in a central portion of the injector housing 2 which lies above the nozzle needle 4. The back pressure unit 5 controls the valve piston 22, that is, the back pressure of the nozzle needle 4 to thereby control the seating and lifting of the nozzle needle 4 via the spring seat 20. An upper portion of the nozzle needle 4 is made to slide within a clearance seal hole 23 in the nozzle body 3. In addition, the spring chamber 19 communicates with the fuel return passage 16 on a low pressure side, whereby the nozzle body 3 separates a high pressure side (the fuel gallery 15) from the low pressure side (the spring chamber 19) at the clearance seal hole 23.

The injector housing 2 has a first contact surface 24 which intersects a longitudinal direction thereof at right angles at an end face which makes up a bottom surface thereof, and the first fuel passage 13 is made to open to the first contact surface 24. On the other hand, the nozzle body 3 has a second contact surface 25 which intersects a longitudinal direction thereof at right angles at an end face which makes up an upper surface thereof, and the second fuel passage 14 is made to open to the second contact surface 25.

A threaded portion 91A is formed on an inner circumferential surface of the nozzle nut 9 which lies in the vicinity of a rear end opening 91, whereas a threaded portion 2A, which are adapted to mate with the threaded portion 91A, are formed on an outer circumferential surface of the injector housing 2. Then, by bringing the threaded portion 91A and the threaded portion 2A into thread engagement with each other and fastening the nozzle nut 9 with a predetermined seat tightening force, the first contact surface 24 and the second contact surface 25 are brought into press contact with each other with the respective openings of the first fuel passage 13 and the second fuel passage 14 made to face each other, so as to secure a predetermined contact surface pressure, so that a high pressure seal portion 26 is formed, whereby a high pressure seal construction is configured which prevents the leakage of the high-pressure fuel from a connecting portion between the first fuel passage 13 and the second fuel passage 14 through which the high-pressure fuel passes.

An annular groove 92 is formed in a portion inside the nozzle nut 9 which faces the high pressure seal portion 26, whereby an annular space 27 for temporarily collecting the high-pressure fuel which has leaked from the high pressure seal portion 26 is formed in such a manner as to include the injector housing 2, the nozzle body 3 and the nozzle nut 9 when the injector housing 2, the nozzle body 3 and the nozzle nut 9 are assembled together as is shown in FIG. 1. In addition, a communication path 28 is formed so as to cause the high-pressure fuel which is temporarily collected in the annular space 27 to escape to the low pressure side of the fuel.

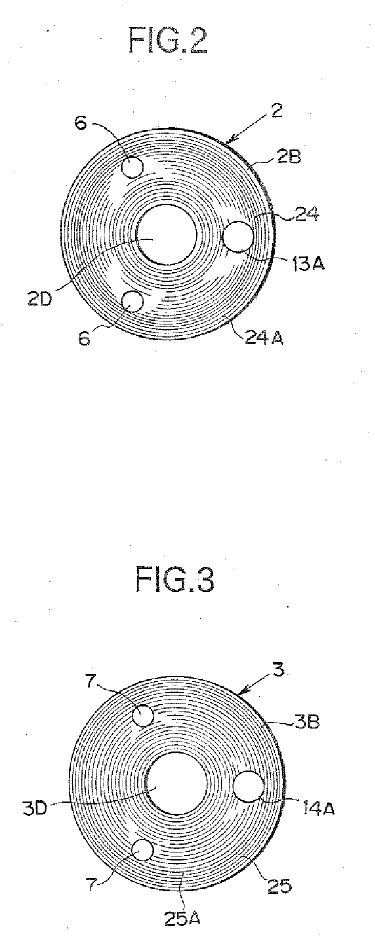

In FIG. 2, a bottom view of the injector housing 2 is shown. A bottom surface 2B, which is a lower end face of the injector housing 2, is made into a flat surface, and on the bottom surface 2B, a bottom-side opening end 13A of the first fuel passage 13 is formed and an opening 2D is provided which communicates with the spring chamber 19.

The bottom surface 2B makes up the first contact surface 24. The second contact surface 25, which faces the first contact surface 24, is formed on the end face of the nozzle body 3. In order to enhance the sealing characteristics of the high pressure seal construction made up of the high pressure seal portion 26 which is formed by bringing the first contact surface 24 and the second contact surface 25 into press contact with each other, the first contact surface 24 is made such that a large number of seal grooves 24A of concentric circle form are formed on the bottom surface 2B. Here, the seal grooves 24A of concentric circle form are such as to be formed by applying finish machining of concentric tool marks to the first contact surface 24, and the seal grooves 24A of concentric circle form are configured in such a form that a large number of arc-shaped grooves are formed densely around the opening 2D.

FIG. 3 is a drawing which shows the second contact surface 25 formed on the upper surface 3B of the nozzle body 3, which makes up the end face thereof. In FIG. 3, 14A denotes an upper surface side open end of the second fuel passage 14, and 3D denotes an open end of the clearance seal hole 23. Seal grooves 25A of concentric circle form are formed also on the second contact surface 25 in a similar manner to that in which the seal grooves 24A are formed. Consequently, the seal grooves 25A of concentric circle form are also configured in such a form that a large number of arc-shaped grooves are formed densely around the open end 3D. The seal grooves 24A, 25A of concentric circle form can be formed by applying the finish machining of concentric tool marks to the respective end faces using, for example, a grinding wheel for finish machining or the like.

Since the first contact surface 24 and the second contact surface 25 are configured as has been described above, when assembled as shown in FIG. 1, with the first contact surface 24 and the second contact surface 25 brought into press contact with each other, projections of the respective grooves which make up the seal grooves 24A of concentric circle form of the first contact surface 24 and projections of the respective grooves which make up the seal grooves 25A of concentric circle form of the second contact surface 25 are made to bite into each other, so as to enhance remarkably the fluid tightness between both the contact surfaces. As a result, since the high pressure sealing characteristics of the high pressure seal portion 26 are enhanced remarkably when compared with a conventional construction, according to the high pressure construction that has been described above, when compared with the conventional structure, higher-pressure fuel can be used.

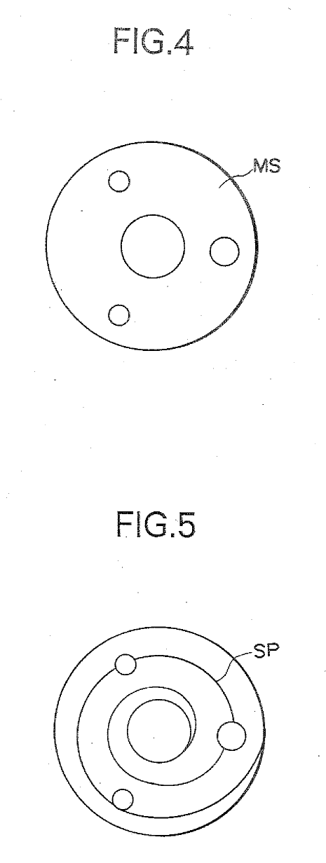

Note that in the embodiment that has been described heretofore, the example has been described in which the seal grooves are formed on both the first contact surface 24 and the second contact surface 25. However, the seal grooves of concentric circle form may only have to be formed on at least either of the first contact surface 24 and the second contact surface 25, and even as this occurs, the sealing characteristics of the high pressure seal portion 26 can remarkably be enhanced when compared with the conventional construction. In the event that the seal grooves of concentric circle form are applied to only one of the contact surfaces, the other contact surface may be a mirror finish which has no groove formed thereon as shown in FIG. 4 or can be made, as shown in FIG. 5, into a contact surface of conventional construction on which a plurality of spiral grooves SP (only one spiral groove is shown in FIG. 5 for the sake of simplicity) are formed by a finish machining with a grinding wheel (face grinding). Alternatively, an appropriate contact surface construction other than those illustrated in FIGS. 4 and 5 may be adopted.

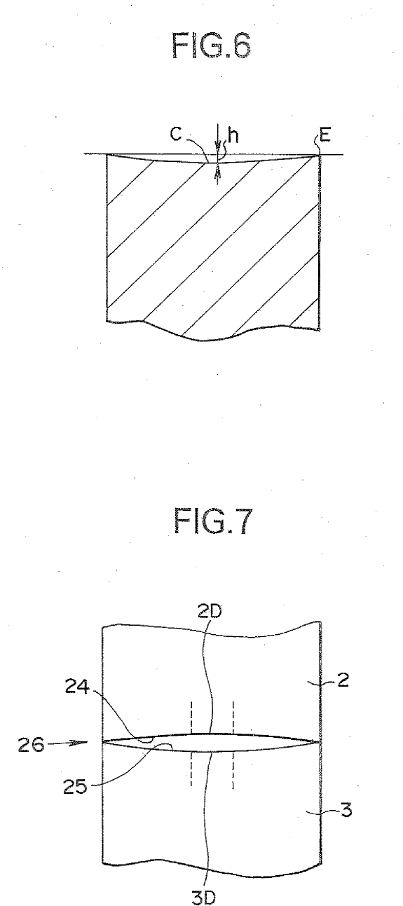

Furthermore, in the embodiment, the first contact surface 24 and the second contact surface 25 are both made into the flat surfaces. However, at least either of the first contact surface 24 and the second contact surface 25 can be, as shown in FIG. 6, made into a concave surface in which a central portion C is made lower relative to a peripheral portion E. As this occurs, the amount of concavity h may be extremely small.

FIG. 7 shows an example of a configuration of the high pressure seal portion 26 in which the first contact surface 24 and the second contact surface 25 are formed into concave surfaces, and in the event that the first contact surface 24 and the second contact surface 25 are brought into press contact with each other, the respective peripheral portions E are brought into press contact with each other so as to be secured together tightly with an extremely large force, thereby making it possible to prevent extremely effectively the leakage of high-pressure fuel from the peripheral portions E. Moreover, a slight gap is formed between the first contact surface 24 and the second contact surface 25 near the central portions thereof. Because of this, since the high-pressure fuel existing within the gap is induced to the open ends 2D, 3D, the sealing effect of the high pressure seal portion 26 can be made much larger.

Since the fuel injector 1 is configured as has been described heretofore, the fuel injector 1 can deal with further high-pressurization of high-pressure fuel with low costs resulting from the application of minor machining to the first contact surface 24 and the second contact surface 25 and without requiring additional parts. Consequently, since no modification has to be made in assembling a product when compared with the conventional construction and no modification has to be made to the exterior of the product, no interference with a cylinder head of an internal combustion engine is generated, and hence, no problem is caused in replacing an injector produced to a conventional specification. In addition, disassembling and recycling products is affected in no way.

Next, a machining method for forming the seal grooves of concentric circle form on the first contact surface 24 and the second contact surface 25 will be described.

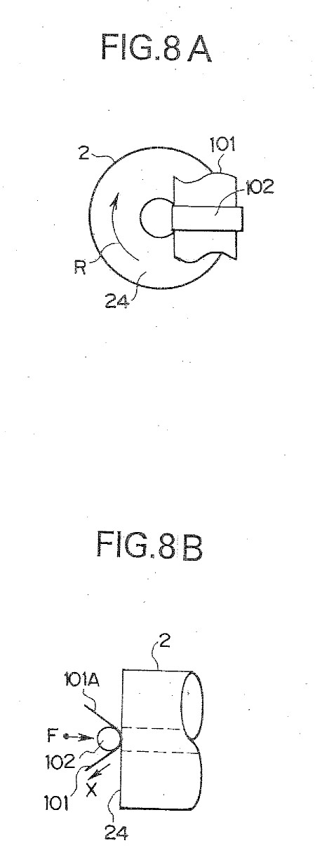

FIGS. 8A and 8B show a machining example in which a super finishing film is employed, of which FIG. 8A is a drawing showing a machining state as seen from the first contact surface 24 of the injector housing 2, and FIG. 8B is a drawing showing the machining state as seen from a side of the injector housing 2. As show in FIGS. 8A, 8B, the injector housing 2 is mounted on a rotary device, not shown, and the injector housing 2 is rotated in a predetermined direction R about an axis of the injector housing 2. As this occurs, the first contact surface 24 comes to rotate within a predetermined plane about a center point thereof.

By pressing a super finishing film 101 against the first contact surface 24 which is rotating as has been described above with a round rod member 102 under a constant force and a constant pressure, respective tips of abrasive grains provided on a main surface 101A of the super finishing film 101 of, for example, #1000-grit to #6000-grit bite into the first contact surface 24 so as to carve arc-shaped seal grooves thereover, whereby seal grooves 24A of concentric circle form are formed. In this case, as is shown in FIG. 8A, the super finishing film 101 is preferably pressed against a half the area of the first contact surface 24. In addition, the round rod member 102 is made of an appropriate material and is preferably made of a rubber or resin material so as to have slight elasticity. By imparting the slight elasticity to the round rod member 102, since the super finishing film 101 can be applied to the first contact surface 24 which is rotating with an appropriate pressing force without any irregularities, the variation in shape of seal grooves formed can be suppressed. Alternatively, as one other method, by using as the round rod member 102 a highly hard or ultra-hard rod member having an R-shape, a concave shape can be formed on the contact surface 24.

Here, it is preferable that the super finishing film 101 is fed by an appropriate feeding mechanism in a direction indicated by an arrow X using the appropriate feeding mechanism and that a fresh grinding surface is fed so as to be applied to the first contact surface 24 at all times.

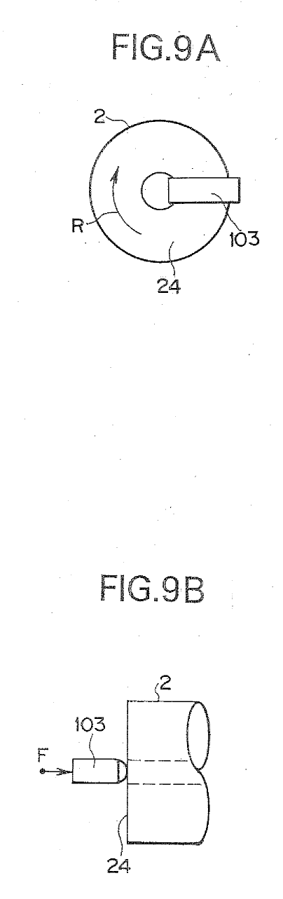

FIGS. 9A, 9B are drawings which explain an example in which a plate-shaped super finishing stick 103 is used in place of the super finishing film 101 to form seal grooves 24A of concentric circle form on the first contact surface 24 of the injector housing 2. FIG. 9A is a drawing showing a machining state as seen from the first contact surface 24 of the injector housing 2, and FIG. 9B is a drawing showing the machining state as seen from a side of the injector housing 2.

Here, a sectional shape of a tip portion 103A of the super finishing stick 103 is substantially a semi-circular shape, and this tip portion 103A is pressed against the first contact surface 24, which is rotating, of the injector housing 2 with an appropriate force in a similar manner to that used in the case shown in FIGS. 8A, 8B by employing an appropriate jig, whereby seal grooves 24A of concentric circle form can be formed on the first contact surface 24 in a similar manner to that used in the case shown in FIGS. 8A, 8B.

Thus, the machining method for forming the seal grooves 24A of concentric circle form on the first contact surface 24 of the injector housing 2 has been described. However, also in the event that seal grooves 24A of concentric circle form are formed on the second contact surface 25 of the nozzle body 3, similar methods to those shown in FIGS. 8A, 8B, 9A, 9B can, of course, be used to obtain similar results.

10 samples were prepared in which the seal grooves of concentric circle form shown, respectively, in FIGS. 2 and 3 were formed on the first contact surface 24 and the second contact surface 25 in the high pressure seal portion 26 of the fuel injector configured as shown in FIG. 1, and micro-leakage evaluations were performed on these 10 samples in the following manner. Gas oil containing therein fluorescent was used, and the occurrence of fuel leakage was examined with the fuel pressure increased by 6% and 20% higher over the current condition. The results showed that no fuel leakage could be found on all the 10 samples with either of the fuel pressures.

Next, comparison four samples of fuel injectors were prepared which had no seal groove of concentric circle form formed thereon but had the conventional high pressure seal portion in which the spiral grooves show in FIG. 5 were used, and the occurrence of fuel leakage was examined in a similar way to that described above. The results showed that although no fuel leakage could be found with the fuel pressure increased by 6% higher over the current condition, with the fuel pressure increased by 20% over the current condition, the occurrence of fuel leakage was confirmed as occurring on all the four samples.

### INDUSTRIAL APPLICABILITY

According to the invention, no micro-leakage occurs even in the event that higher-pressure fuel is used, and hence, the invention serves to improve fuel injectors.

1-12. (canceled)

13. A high pressure seal for a fuel injector including an injector housing having an end face, a first fluid passage in the housing opening into the housing end face, a nozzle body having an end face, a second fluid passage in the body opening into the body end face, means pressing the housing end face and the body end face together with the first and second fluid passages in communication with one another to form a high pressure seal therebetween, and a plurality of grooves of concentric circle form formed in at least one of the end faces.

14. A high pressure seal construction for a fuel injector as set forth in claim 13, wherein the grooves of concentric circle form are formed in both the housing end face and the nozzle body end face.

15. A high pressure seal construction for a fuel injector as set forth in claim 13, wherein the grooves of concentric circle form are formed in only one end face and the other end face is formed with a mirror finish.

16. A high pressure seal construction for a fuel injector as set forth in claim 13, wherein the grooves of concentric circle form are formed in only one end face and spiral grooves are formed in the other end face.

17. A high pressure seal construction for a fuel injector as set forth in claim 13, wherein at least one of the end faces has a concave surface.

18. A high pressure seal construction for a fuel injector as set forth in claim 14, wherein at least one of the end faces has a concave surface.

19. A high pressure seal construction for a fuel injector as set forth in claim 15, wherein at least one of the end faces has a concave surface.

20. A high pressure seal construction for a fuel injector as set forth in claim 16, wherein at least one of the end faces has a concave surface.

21. A high pressure seal construction for a fuel injector as set forth in claim 13, wherein both the housing end face and the nozzle body end face have a concave shape surface.

22. A high pressure seal construction for a fuel injector as set forth in claim 14, wherein both the housing end face and the nozzle body end face have a concave shape surface.

23. A high pressure seal construction for a fuel injector as set forth in claim 15, wherein both the housing end face and the nozzle body end face have a concave shape surface.

24. A high pressure seal construction for a fuel injector as set forth in claim 16, wherein both the housing end face and the nozzle body end face have a concave shape surface.

25. A method for finish machining a high pressure contact surface on an injector housing or a nozzle body of a fuel injector, the method comprising bringing a finish machining tool into pressure contact with the high pressure contact surface while rotating the injector housing or the nozzle body about an axis thereof as a rotating axis to thereby apply finish machining of concentric tool marks to the high pressure contact surface.

26. A method for finish machining a high pressure contact surface as set forth in claim 25, wherein the finish machining tool is a super finishing stick.

27. A fuel injector which comprises a high pressure seal construction as set forth in claim 13.

28. A fuel injector which comprises a high pressure seal construction as set forth in claim 14.

29. A fuel injector which comprises a high pressure seal construction as set forth in claim 15.

30. A fuel injector which comprises a high pressure seal construction as set forth in claim 16.

31. A fuel injector which comprises a high pressure seal construction as set forth in claim 17.

32. A fuel injector which comprises a high pressure seal construction as set forth in claim 21.
